(19) United States
(12) Patent Application Publication
(10) Pub. No.: US 2017/0090557 A1
(43) Pub. Date: Mar. 30, 2017

(54) Systems and Devices for Implementing a Side-Mounted Optical Sensor

(71) Applicant: Google Inc., Mountain View, CA (US)

(72) Inventors: Hayes Solos Raffle, Mountain View, CA (US); Bo Wu, Mountain View, CA (US); David Sparks, Mountain View, CA (US); Seungyon Lee, Mountain View, CA (US); Peter Michael Cazalet, Mountain View, CA (US)

(73) Assignee: Google Inc., Mountain View, CA (US)

(21) Appl. No.: 14/264,935

(22) Filed: Apr. 29, 2014

Related U.S. Application Data
(60) Provisional application No. 61/933,198, filed on Jan. 29, 2014.

(51) Int. Cl. G06F 3/01; G02B 27/01

(52) U.S. Cl. CPC G06F 3/013; G02B 27/0176; G02B 2027/0178

(57) ABSTRACT

This disclosure relates to example implementations for side-mounted optical sensors for eye gestures on a head mountable display. An example wearable computing device may include a wearable frame structure that includes a front portion and at least one side arm. In some instances, ends of the side arms may couple and extend away from the front portion at a coupling point. Additionally, the example device may include optical elements coupled to the front portion and may further include one or more sensors arranged on an inner surface of a side arm proximal to the coupling point. The sensors may be oriented to receive sensor data from at least one eye region when the wearable computing device is worn.

### CROSS REFERENCE TO RELATED APPLICATION

The present disclosure claims priority to U.S. provisional patent application Ser. No. 61/933,198 filed on Jan. 29, 2014, the entire contents of which are herein incorporated by reference.

### BACKGROUND

Unless otherwise indicated herein, the materials described in this section are not prior art to the claims in this application and are not admitted to be prior art by inclusion in this section.

Computing devices such as personal computers, laptop computers, tablet computers, cellular phones, and countless types of Internet-capable devices are increasingly prevalent in numerous aspects of modern life. Over time, the manner in which these devices are providing information to users is becoming more intelligent, more efficient, more intuitive, and/or less obtrusive.

The trend toward miniaturization of computing hardware, peripherals, as well as of sensors, detectors, and image and audio processors, among other technologies, has helped open up a field sometimes referred to as “wearable computing.” In the area of image and visual processing and production, in particular, it has become possible to consider wearable displays that place a graphic display close enough to a wearer's (or user's) eye(s) such that the displayed image appears as a normal-sized image, such as might be displayed on a traditional image display device. The relevant technology may be referred to as “near-eye displays.”

Wearable computing devices with near-eye displays may also be referred to as “head-mountable displays” (HMDs), “head-mounted displays,” “head-mounted devices,” or “head-mountable devices.” A head-mountable display places a graphic display or displays close to one or both eyes of a wearer. To generate the images on a display, a computer processing system may be used. Such displays may occupy a wearer's entire field of view, or only occupy part of wearer's field of view. Further, head-mounted displays may vary in size, taking a smaller form such as a glasses-style display or a larger form such as a helmet, for example.

Emerging and anticipated uses of wearable displays include applications in which users interact in real time with an augmented or virtual reality. Such applications can be mission-critical or safety-critical, such as in a public safety or aviation setting. The applications can also be recreational, such as interactive gaming. Many other applications are also possible.

### SUMMARY

This disclosure may disclose, inter alia, implementing systems and devices for implementing a side-mounted optical sensor.

In one aspect, an example device is described. The example device may take the form of a head-mountable display (HMD), which may include a wearable frame structure comprising a front portion and at least one side arm, and a given end of the at least one side arm is coupled to the front portion at a coupling point and the at least one side arm extends away from the front portion at the coupling point. The example device may further include one or more sensors arranged on an inner surface of the at least one side arm proximal to the coupling point, and the one or more sensors are oriented to receive sensor data from at least one eye region when the head-mountable display is worn.

In another aspect, another example device is described. The example device may also take the form of a head-mountable display (HMD), which may include a wearable frame structure comprising a front portion and at least one side arm and the front portion is configured to hold one or more optical elements in front of at least one eye region when the HMD is worn. The example device may further be configured that a given end of the at least one side arm is coupled to the front portion at a coupling point and the at least one side arm extends away from the front portion at the coupling point. In addition, the example device may include one or more optical elements coupled to the front portion and may also include one or more sensors arranged on an inner surface of the at least one side arm proximal to the coupling point, and where the one or more sensors are oriented to receive sensor data from at least one eye region when the head-mountable display is worn.

In a further aspect, an example system is described. The example system may include a wearable frame structure comprising a front portion and at least one side arm, and where a given end of the at least one side arm is coupled to the front portion at a coupling point and the at least one side arm extends away from the front portion at the coupling point. The example system may also include a display coupled to the wearable frame structure, and the display is configured to display information. The example system may further include one or more sensors arranged on an inner surface of the at least one side arm proximal to the coupling point, and where the one or more sensors are oriented to receive sensor data from at least one eye region when the head-mountable display is worn.

In yet an additional aspect, a system is providing that comprises a means for receiving sensor data from one or more sensors arranged on an inner surface of at least one side arm proximal to a coupling point with a front section of a wearable frame structure. The system may also include means for determining whether the sensor data corresponds to an eye gesture requiring the system to execute one or more functions.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1A illustrates a wearable computing system according to an example embodiment.

FIG. 1B illustrates an alternate view of the wearable computing device illustrated in FIG. 1A.

FIG. 1C illustrates another wearable computing system according to an example embodiment.

FIG. 1D illustrates another wearable computing system according to an example embodiment.

FIGS. 1E to 1G are simplified illustrations of the wearable computing system shown in FIG. 1D, being worn by a wearer.

FIG. 2 is a simplified block diagram of a computing device according to an example embodiment.

FIG. 3 illustrates an example wearable computing device for implementing side-mounted optical sensors.

FIG. 4 illustrates another example wearable computing device for implementing side-mounted optical sensors for detecting eye gestures from an example user.

FIG. 5 illustrates another view of an example wearable computing device for implementing side-mounted optical sensors for detecting eye gestures from an example user.

FIG. 6 is a schematic illustrating a conceptual partial view of an example computer program product that includes a computer program for executing a computer process on a computing device.

### DETAILED DESCRIPTION

The following detailed description describes various features and functions of the disclosed systems and methods with reference to the accompanying figures. In the figures, similar symbols identify similar components, unless context dictates otherwise. The illustrative system and method embodiments described herein are not meant to be limiting. It may be readily understood that certain aspects of the disclosed systems and methods can be arranged and combined in a wide variety of different configurations, all of which are contemplated herein.

A computing device, such as a head-mountable display (HMD) also known as a head-mountable device or other system, may enable communication between components of the HMD and a user through a variety of means, such as eye gesture inputs or other movements that other devices may be unable to utilize. In some example implementations of wearable computing devices, examples, such as an HMD, may include a wearable frame structure configured with a front portion and one or more side arms. The one or more side arms may connect to the front portion at a coupling point and may extend away from the front portion at the coupling point. Together, the front portion and side arms may form a structure similar to eye glasses. The front portion may be configured in some instances to hold or support optical elements, such as prescription lens, regular lens, sunglass lens, etc. In some instances, the HMD may exist with an optical element, multiple optical elements, or not optical elements at all. Other configurations may exist as well.

In addition, the HMD may also include one or multiple sensors configured to capture sensor data. The types of sensors may vary, which may include an HMD using image capturing sensors or proximity sensors, for example. An HMD may include camera(s), sensor array(s), image sensor(s), light sensor(s), and infrared sensor(s). Other types of sensors may be used as well.

Likewise, the different sensors of an HMD may capture sensor data corresponding to a variety of elements, which may include capturing movement data or light data produced by body elements of a user. For example, an HMD may receive sensor data from sensors corresponding to an eye region or eye regions of a user. An eye region may vary within different implementations, which may include a sensor focusing upon pupils of the eye, the eye in general, eye lids, a corner or the corners of the eye, or other regions associated with an eye. Further, in other example implementations, an HMD may receive sensor data corresponding to other elements or body parts of a user. The sensor data may be utilized by a processor or other component of the HMD to determine inputs provided by a user, such as providing input through eye gestures.

In some implementations, any sensors or a portion of sensors of the HMD may be arranged on an inner surface of a side arm or both side arms of the HMD and may further be positioned proximal to the coupling point (i.e., where the side arm attaches to the front portion of the HMD). By locating the sensors on the side of the HMD, such as on the inner surface of a side arm extending away from the front portion, the sensors may be able to capture sensor data from a slightly side view of the eye allowing the interference-free reception by the sensor free from any optical elements that may be attached to the wearable structure.

As previously indicated, during operation, the sensors may capture sensor data that corresponds to different portions of a user's eye as the HMD is being worn. For example, the sensors may detect light data or other information from positioning or movement of a user's eye lids, or the movement of the eye's pupil. Likewise, the sensors may be positioned in a manner that focuses upon a subsection of the user's eye when the HMD is being worn, such as an outside corner of the user's eye. In such an example, the sensors may receive information corresponding to different elements relating to the outside corner of the user's eye, such as the upper and/or lower eye lid, for example.

Furthermore, in some implementations, an HMD may include one or multiple sensors configured to capture sensor data within a package of some structure, which may also provide housing for other electronics (e.g., wiring, light sources, batteries, etc.) of the HMD. The package may be attached to the inner surface of a side arm of the HMD, which may include the package having a position proximal to the coupling point where the side arm connects to the front portion of the HMD. Additionally, the package may also be positioned in a manner that positions the package proximal or within a threshold distance from a user's temple when the HMD is being worn. For example, the package may be positioned within a few centimeters (e.g., 0.5-3 cm) of a user's temple when the HMD is worn. Other distances may qualify as proximal within other implementations. Likewise, other locations of the package as well as the sensors may exist within other example implementations as well.

In another implementation, an example HMD may include sensors arranged directly on an inner surface of an arm of the HMD. The sensors may be positioned within the arm (e.g., embedded) or may be attached via some structure to the inner surface of an arm of the HMD. The sensors may be arranged proximal relative to the coupling point and may also be positioned based on further constraints, which may orientate the sensors to receive sensor data from a wide angle positioned on a side relative to a user's eye. The different types of sensors may capture data corresponding to various body elements of a user, which may occur when the HMD is being worn or not being worn, depending on the configuration of the HMD. For example, sensors may capture light data, images, or movement data corresponding to a user's eye, muscles positioned around a user's eye (e.g., eye lids, cheek muscles), or other body elements.

Systems and devices in which example embodiments may be implemented will now be described in greater detail. In general, an example system may be implemented in or may take the form of a wearable computer (also referred to as a wearable computing device). In an example embodiment, a wearable computer takes the form of or includes a head-mountable device or head-mountable display (HMD).

An example system may also be implemented in or take the form of other devices, such as a mobile phone, among other possibilities. Further, an example system may take the form of non-transitory computer readable medium, which has program instructions stored thereon that are executable by at a processor to provide the functionality described herein. An example system may also take the form of a device such as a wearable computer or mobile phone, or a subsystem of such a device, which includes such a non-transitory computer readable medium having such program instructions stored thereon.

An HMD may generally be any display device that is capable of being worn on the head and places a display in front of one or both eyes of the wearer. An HMD may take various forms such as a helmet or eyeglasses. As such, references to “eyeglasses” or a “glasses-style” HMD should be understood to refer to an HMD that has a glasses-like frame so that it can be worn on the head. Further, example embodiments may be implemented by or in association with an HMD with a single display or with two displays, which may be referred to as a “monocular” HMD or a “binocular” HMD, respectively.

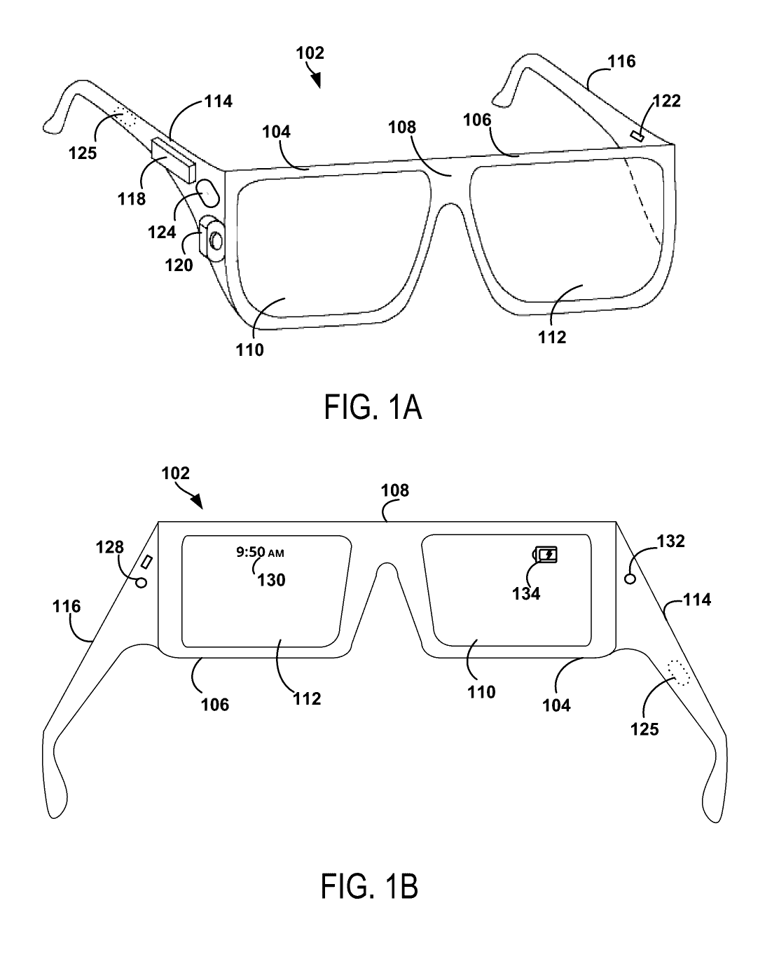

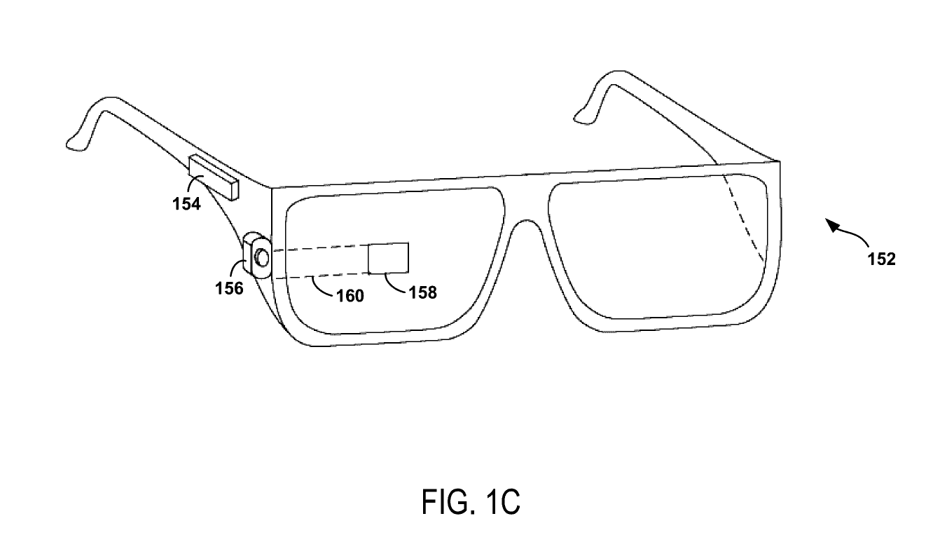

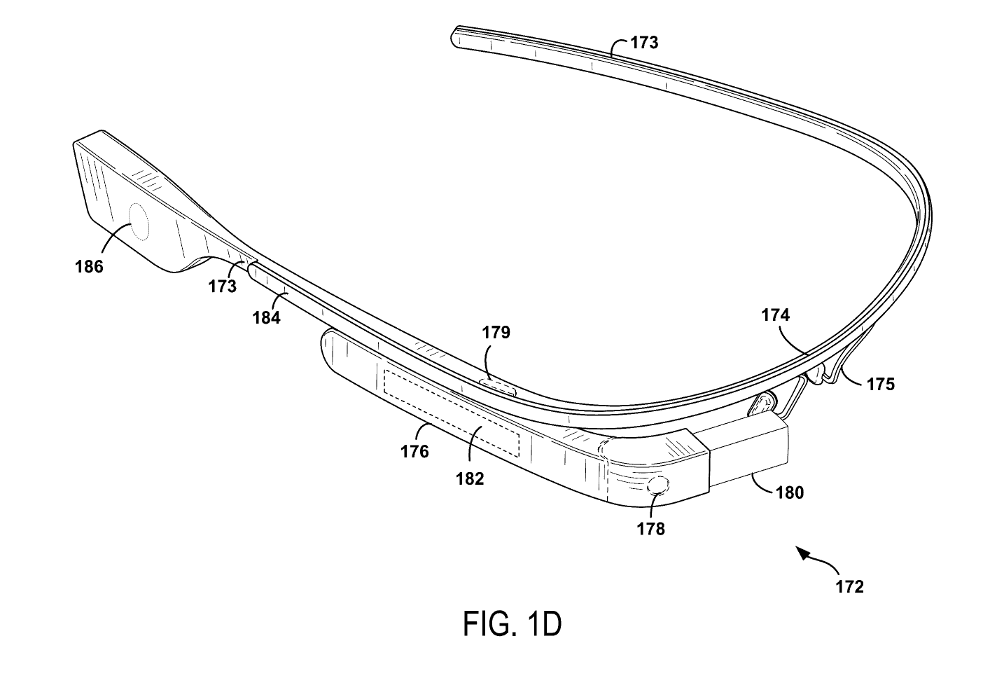

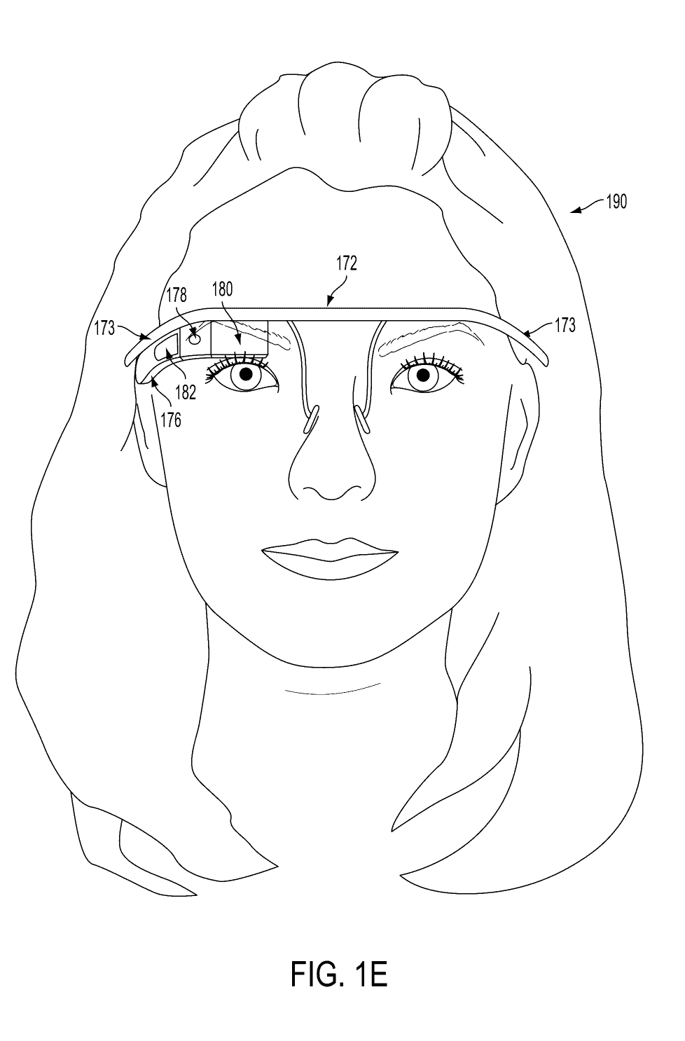

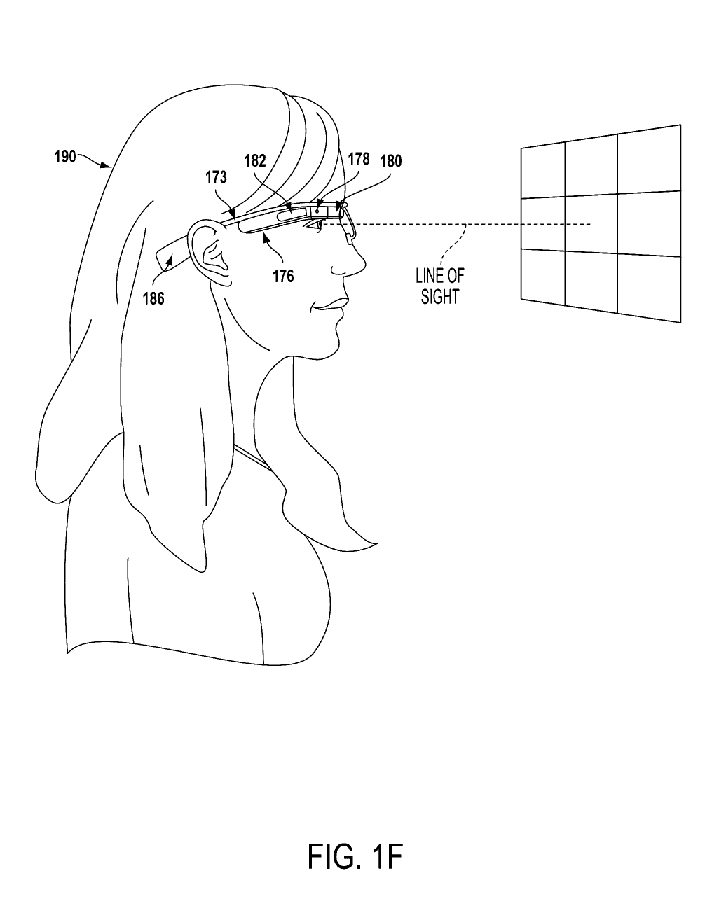

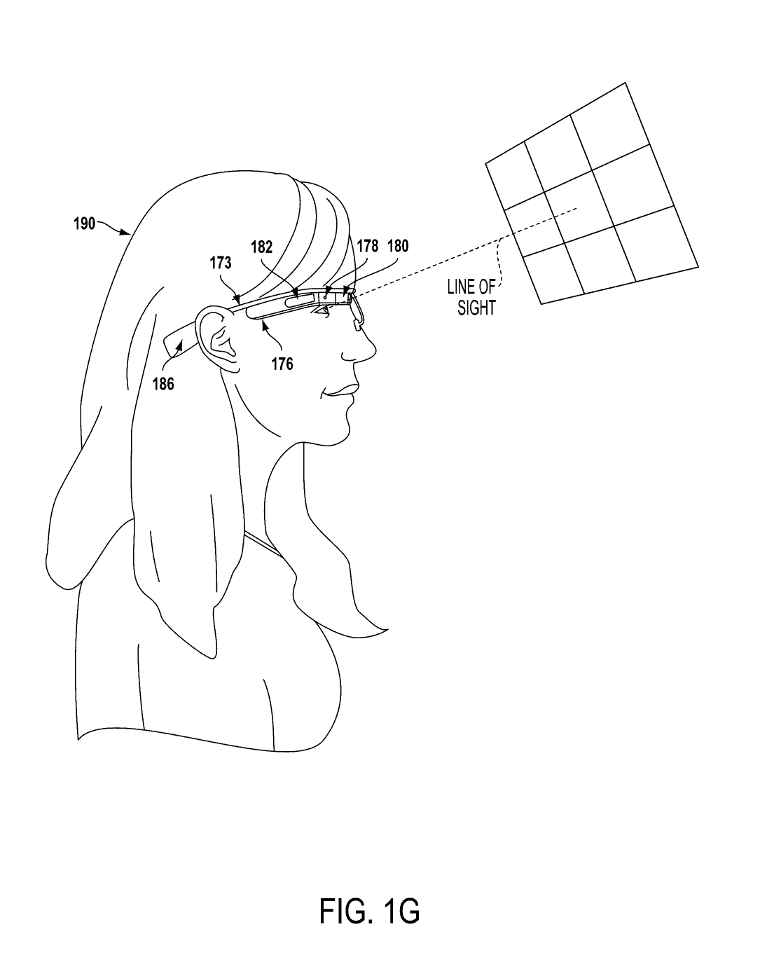

FIG. 1A illustrates a wearable computing system according to an example embodiment. In FIG. 1A, the wearable computing system takes the form of a head-mountable display (HMD) 102 (which may also be referred to as a head-mounted device). It should be understood, however, that example systems and devices may take the form of or be implemented within or in association with other types of devices, without departing from the scope of the invention. As illustrated in FIG. 1A, the HMD 102 may include frame elements, including lens-frames 104, 106 and a center frame support 108, lens elements 110, 112, and extending side-arms 114, 116. The center frame support 108 and the extending side-arms 114, 116 are configured to secure the HMD 102 to a user's face via a user's nose and ears, respectively.

Each of the frame elements 104, 106, and 108 and the extending side-arms 114, 116 may be formed of a solid structure of plastic and/or metal, or may be formed of a hollow structure of similar material so as to allow wiring and component interconnects to be internally routed through the HMD 102. Other materials may be possible as well.

One or more of each of the lens elements 110, 112 or optical elements may be formed of any material that can suitably display a projected image or graphic. Each of the lens elements 110, 112 may also be sufficiently transparent to allow a user to see through the lens element. Combining these two features of the lens elements may facilitate an augmented reality or heads-up display where the projected image or graphic is superimposed over a real-world view as perceived by the user through the lens elements.

The extending side-arms 114, 116 may each be projections that extend away from the lens-frames 104, 106, respectively, and may be positioned behind a user's ears to secure the HMD 102 to the user. The extending side-arms 114, 116 may further secure the HMD 102 to the user by extending around a rear portion of the user's head. The extending side-arms 114, 116 may be configured to hold or connect to other components that the HMD 102 may use. For example, the extending side-arms 114, 116 may be configured to connect with sensors configured to capture data for the HMD 102. Additionally or alternatively, for example, the HMD 102 may connect to or be affixed within a head-mounted helmet structure. Other configurations for an HMD are also possible.

The HMD 102 may also include an on-board computing system 118, an image capture device 120, a sensor 122, and a finger-operable touch pad 124. The on-board computing system 118 is shown to be positioned on the extending side-arm 114 of the HMD 102; however, the on-board computing system 118 may be provided on other parts of the HMD 102 or may be positioned remote from the HMD 102 (e.g., the on-board computing system 118 could be wire- or wirelessly-connected to the HMD 102). The on-board computing system 118 may include a processor and memory, for example. The on-board computing system 118 may be configured to receive and analyze data from the image capture device 120 and the finger-operable touch pad 124 (and possibly from other sensory devices, user interfaces, or both) and generate images for output by the lens elements 110 and 112.

The image capture device 120 may be, for example, a camera that is configured to capture still images and/or to capture video. In the illustrated configuration, image capture device 120 is positioned on the extending side-arm 114 of the HMD 102; however, the image capture device 120 may be provided on other parts of the HMD 102. For example, an HMD may include image capturing devices positioned on an inner surface of an extending arm, which may enable the image capturing devices to capture images of a user's eye regions when the HMD is being worn. Similarly, the image capturing device 120 may operate within a system of image capturing devices positioned on the HMD 102. The image capture device 120 may be configured to capture images at various resolutions or at different frame rates. Many image capture devices with a small form-factor, such as the cameras used in mobile phones or webcams, for example, may be incorporated into an example of the HMD 102. The image capture device 120 may operate in addition to proximity devices of the HMD 102.

Further, although FIG. 1A illustrates one image capture device 120, more image capture device may be used, and each may be configured to capture the same view, or to capture different views. For example, the image capture device 120 may be forward facing to capture at least a portion of the real-world view perceived by the user. This forward facing image captured by the image capture device 120 may then be used to generate an augmented reality where computer generated images appear to interact with or overlay the real-world view perceived by the user. The image capture device 120 may be positioned to capture images of a user's face or eye region, which may involve positioning the image capturing device in a position on the HMD enabling the image capturing device to capture images at various angles.

Additionally, an HMD 102 may further include a variety of sensors configured to capture information for the HMD 102 to process. The sensor 122 is shown on the inner side of extending side-arm 116 of the HMD 102; however, the sensor 122 may be positioned on other parts of the HMD 102. The sensor 122 may be connected on the inner portion of the extending side-arm 116 in order to capture sensor data corresponding to an eye of a user when the HMD 102 is being worn. For example, the sensor 122 may be positioned on the inner surface of the extending side-arm 116 proximal to the point that the extending side-arm 116 connects to the front frame element 106. In some examples, the sensors 122 may be configured within a threshold distance from the frame element 106 connection to the extending side-arm 116.

For illustrative purposes, only one sensor 122 is shown. However, in other example implementations, the HMD 102 may include multiple sensors. For example, an HMD 102 may include sensors 102 such as one or more gyroscopes, one or more accelerometers, one or more magnetometers, one or more light sensors, one or more infrared sensors, one or more proximity sensors, one or more temperature sensors, and/or one or more microphones. The sensors, such as sensor 102, may be configured to obtain sensor data corresponding to a user's eye region or other body elements when the device is being worn. Other sensing devices may be included in addition or in the alternative to the sensors that are specifically identified herein.

In some instances, by positioning sensors on the inner surface of the extending side-arm 116, the HMD 102 may be able to include lenses positioned at lens elements 110-112. For example, the HMD 102 may include prescription lens for lens elements 110-112 and may be configured with sensors, such as sensor 122, configured to receive sensor data corresponding to a user's eye region when the HMD 102 may be worn. The sensors 122 may receive sensor data without interference from lens elements 110-112 due to the positioning of the sensors 122 on the side of the HMD 102.

The finger-operable touch pad 124 is shown on the extending side-arm 114 of the HMD 102. However, the finger-operable touch pad 124 may be positioned on other parts of the HMD 102. Also, more than one finger-operable touch pad may be present on the HMD 102. The finger-operable touch pad 124 may be used by a user to input commands. The finger-operable touch pad 124 may sense at least one of a pressure, position and/or a movement of one or more fingers via capacitive sensing, resistance sensing, or a surface acoustic wave process, among other possibilities. The finger-operable touch pad 124 may be capable of sensing movement of one or more fingers simultaneously, in addition to sensing movement in a direction parallel or planar to the pad surface, in a direction normal to the pad surface, or both, and may also be capable of sensing a level of pressure applied to the touch pad surface.

In some embodiments, the finger-operable touch pad 124 may be formed of one or more translucent or transparent insulating layers and one or more translucent or transparent conducting layers. Edges of the finger-operable touch pad 124 may be formed to have a raised, indented, or roughened surface, so as to provide tactile feedback to a user when the user's finger reaches the edge, or other area, of the finger-operable touch pad 124. If more than one finger-operable touch pad is present, each finger-operable touch pad may be operated independently, and may provide a different function.

In a further aspect, the HMD 102 may be configured to receive user input in various ways, in addition or in the alternative to user input received via finger-operable touch pad 124. For example, on-board computing system 118 may implement a speech-to-text process and utilize a syntax that maps certain spoken commands to certain actions. In addition, the HMD 102 may include one or more microphones via which a wearer's speech may be captured. Configured as such, the HMD 102 may be operable to detect spoken commands and carry out various computing functions that correspond to the spoken commands.

As another example, the HMD 102 may interpret certain head-movements as user input. For example, when the HMD 102 is worn, the HMD 102 may use one or more gyroscopes and/or one or more accelerometers to detect head movement. The HMD 102 may then interpret certain head-movements as being user input, such as nodding, or looking up, down, left, or right. An HMD 102 could also pan or scroll through graphics in a display according to movement. Other types of actions may also be mapped to head movement.

As yet another example, the HMD 102 may interpret certain gestures (e.g., by a wearer's hand or hands) as user input. For example, the HMD 102 may capture hand movements by analyzing image data from image capture device 120, and initiate actions that are defined as corresponding to certain hand movements.

As a further example, the HMD 102 may interpret eye movement or eye gestures as user input. In particular, the HMD 102 may include one or more inward-facing image capture devices and/or one or more other inward-facing sensors (not shown) sense a user's eye movements and/or positioning. As such, certain eye movements may be mapped to certain actions. For example, certain actions may be defined as corresponding to movement of the eye in a certain direction, a blink, and/or a wink, among other possibilities. The HMD 102 may be configured to determine whether sensor data represents a specific eye gesture, for example.

The HMD 102 also includes a speaker 125 for generating audio output. In one example, the speaker could be in the form of a bone conduction speaker, also referred to as a bone conduction transducer (BCT). Speaker 125 may be, for example, a vibration transducer or an electroacoustic transducer that produces sound in response to an electrical audio signal input. The frame of the HMD 102 may be designed such that when a user wears the HMD 102, the speaker 125 contacts the wearer. Alternatively, speaker 125 may be embedded within the frame of HMD 102 and positioned such that, when the HMD 102 is worn, speaker 125 vibrates a portion of the frame that contacts the wearer. In either case, the HMD 102 may be configured to send an audio signal to speaker 125, so that vibration of the speaker may be directly or indirectly transferred to the bone structure of the wearer. When the vibrations travel through the bone structure to the bones in the middle ear of the wearer, the wearer can interpret the vibrations provided by BCT 125 as sounds.

Various types of bone-conduction transducers (BCTs) may be implemented, depending upon the particular implementation. Generally, any component that is arranged to vibrate the HMD 102 may be incorporated as a vibration transducer. Yet further it should be understood that an HMD 102 may include a single speaker 125 or multiple speakers. In addition, the location(s) of speaker(s) on the HMD may vary, depending upon the implementation. For example, a speaker may be located proximate to a wearer's temple (as shown), behind the wearer's ear, proximate to the wearer's nose, and/or at any other location where the speaker 125 can vibrate the wearer's bone structure.

FIG. 1B illustrates an alternate view of the wearable computing device illustrated in FIG. 1A. As shown in FIG. 1B, the lens elements 110, 112 may act as display elements. The HMD 102 may include a first projector 128 coupled to an inside surface of the extending side-arm 116 and configured to project a display 130 onto an inside surface of the lens element 112. Additionally or alternatively, a second projector 132 may be coupled to an inside surface of the extending side-arm 114 and configured to project a display 134 onto an inside surface of the lens element 110.

The lens elements 110, 112 may act as a combiner in a light projection system and may include a coating that reflects the light projected onto them from the projectors 128, 132. In some embodiments, a reflective coating may not be used (e.g., when the projectors 128, 132 are scanning laser devices).

In alternative embodiments, other types of display elements may also be used. For example, the lens elements 110, 112 themselves may include: a transparent or semi-transparent matrix display, such as an electroluminescent display or a liquid crystal display, one or more waveguides for delivering an image to the user's eyes, or other optical elements capable of delivering an in focus near-to-eye image to the user. A corresponding display driver may be disposed within the frame elements 104, 106 for driving such a matrix display. Alternatively or additionally, a laser or LED source and scanning system could be used to draw a raster display directly onto the retina of one or more of the user's eyes. Other possibilities exist as well.

FIG. 1C illustrates another wearable computing system according to an example embodiment, which takes the form of an HMD 152. The HMD 152 may include frame elements and side-arms such as those described with respect to FIGS. 1A and 1B. The HMD 152 may additionally include an on-board computing system 154 and an image capture device 156, such as those described with respect to FIGS. 1A and 1B. The image capture device 156 is shown mounted on a frame of the HMD 152. However, the image capture device 156 may be mounted at other positions as well.

As shown in FIG. 1C, the HMD 152 may include a single display 158 which may be coupled to the device. The display 158 may be formed on one of the lens elements of the HMD 152, such as a lens element described with respect to FIGS. 1A and 1B, and may be configured to overlay computer-generated graphics in the user's view of the physical world. The display 158 is shown to be provided in a center of a lens of the HMD 152, however, the display 158 may be provided in other positions, such as for example towards either the upper or lower portions of the wearer's field of view. The display 158 is controllable via the computing system 154 that is coupled to the display 158 via an optical waveguide 160.

FIG. 1D illustrates another wearable computing system according to an example embodiment, which takes the form of a monocular HMD 172. The HMD 172 may include side-arms 173, a center frame support 174, and a bridge portion with nosepiece 175. In the example shown in FIG. 1D, the center frame support 174 connects the side-arms 173. The HMD 172 does not include lens-frames containing lens elements. In some instances, the HMD 172 may be configured to include lens elements. The HMD 172 may additionally include a component housing 176, which may include an on-board computing system (not shown), an image capture device 178, and a button 179 for operating the image capture device 178 (and/or usable for other purposes). Component housing 176 may also include other electrical components and/or may be electrically connected to electrical components at other locations within or on the HMD. HMD 172 also includes a BCT 186. For example, the component housing 176 may include sensors configured to capture sensing data corresponding regions of a user, such as a user's eye and eyelids, when the HMD 172 may be worn. The sensors may be positioned within the component housing 176 near a temple of a user when the HMD 172 is being worn to enable the HMD 172 to have lens elements.

The HMD 172 may include a single display 180, which may be coupled to one of the side-arms 173 via the component housing 176. In an example embodiment, the display 180 may be a see-through display, which is made of glass and/or another transparent or translucent material, such that the wearer can see their environment through the display 180. Further, the component housing 176 may include the light sources (not shown) for the display 180 and/or optical elements (not shown) to direct light from the light sources to the display 180. As such, display 180 may include optical features that direct light that is generated by such light sources towards the wearer's eye, when HMD 172 is being worn.

In a further aspect, HMD 172 may include a sliding feature 184, which may be used to adjust the length of the side-arms 173. Thus, sliding feature 184 may be used to adjust the fit of HMD 172. Further, an HMD may include other features that allow a wearer to adjust the fit of the HMD, without departing from the scope of the invention.

FIGS. 1E to 1G are simplified illustrations of the HMD 172 shown in FIG. 1D, being worn by a wearer 190. As shown in FIG. 1F, when the HMD 172 is worn, BCT 186 is arranged such that when the HMD 172 is worn, BCT 186 is located behind the wearer's ear. As such, BCT 186 is not visible from the perspective shown in FIG. 1E.

In the illustrated example, the display 180 may be arranged such that when the HMD 172 is worn, display 180 is positioned in front of or proximate to a user's eye when the HMD 172 is worn by a user. For example, display 180 may be positioned below the center frame support and above the center of the wearer's eye, as shown in FIG. 1E. Further, in the illustrated configuration, display 180 may be offset from the center of the wearer's eye (e.g., so that the center of display 180 is positioned to the right and above of the center of the wearer's eye, from the wearer's perspective).

Configured as shown in FIGS. 1E to 1G, display 180 may be located in the periphery of the field of view of the wearer 190, when HMD 172 is worn. Thus, as shown by FIG. 1F, when the wearer 190 looks forward, the wearer 190 may see the display 180 with their peripheral vision. As a result, display 180 may be outside the central portion of the wearer's field of view when their eye is facing forward, as it commonly is for many day-to-day activities. Such positioning can facilitate unobstructed eye-to-eye conversations with others, as well as generally providing unobstructed viewing and perception of the world within the central portion of the wearer's field of view. Further, when the display 180 is located as shown, the wearer 190 may view the display 180 by, e.g., looking up with their eyes only (possibly without moving their head). This is illustrated as shown in FIG. 1G, where the wearer has moved their eyes to look up and align their line of sight with display 180. A wearer might also use the display by tilting their head down and aligning their eye with the display 180.

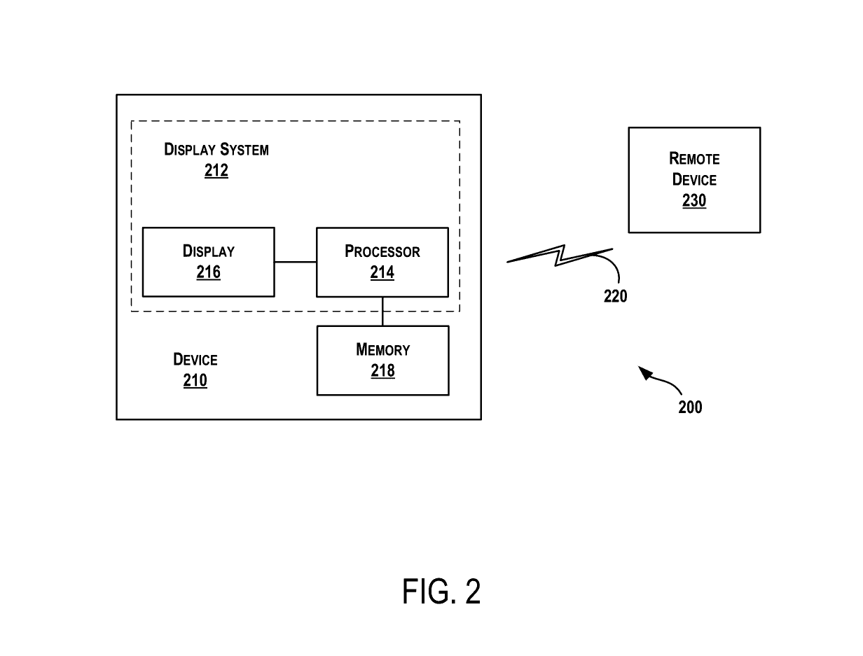

FIG. 2 is a simplified block diagram a computing device 210 according to an example embodiment. In an example embodiment, device 210 communicates using a communication link 220 (e.g., a wired or wireless connection) to a remote device 230. The device 210 may be any type of device that can receive data and display information corresponding to or associated with the data. For example, the device 210 may take the form of or include a head-mountable display, such as the head-mounted devices 102, 152, or 172 that are described with reference to FIGS. 1A to 1G.

The device 210 may include a processor 214 and a display 216. The display 216 may be, for example, an optical see-through display, an optical see-around display, or a video see-through display. The processor 214 may receive data from the remote device 230, and configure the data for display on the display 216. The processor 214 may be any type of processor, such as a micro-processor or a digital signal processor, for example. The device 210 may further include on-board data storage, such as memory 218 coupled to the processor 214. The memory 218 may store software that can be accessed and executed by the processor 214, for example.

The remote device 230 may be any type of computing device or transmitter including a laptop computer, a mobile telephone, head-mountable display, tablet computing device, etc., that is configured to transmit data to the device 210. The remote device 230 and the device 210 may contain hardware to enable the communication link 220, such as processors, transmitters, receivers, antennas, etc.

Further, remote device 230 may take the form of or be implemented in a computing system that is in communication with and configured to perform functions on behalf of client device, such as computing device 210. Such a remote device 230 may receive data from another computing device 210 (e.g., an HMD 102, 152, or 172 or a mobile phone), perform certain processing functions on behalf of the device 210, and then send the resulting data back to device 210. This functionality may be referred to as “cloud” computing.

In FIG. 2, the communication link 220 is illustrated as a wireless connection; however, wired connections may also be used. For example, the communication link 220 may be a wired serial bus such as a universal serial bus or a parallel bus. A wired connection may be a proprietary connection as well. The communication link 220 may also be a wireless connection using, e.g., Bluetooth® radio technology, communication protocols described in IEEE 802.11 (including any IEEE 802.11 revisions), Cellular technology (such as GSM, CDMA, UMTS, EV-DO, WiMAX, or LTE), or Zigbee® technology, among other possibilities. The remote device 230 may be accessible via the Internet and may include a computing cluster associated with a particular web service (e.g., social-networking, photo sharing, address book, etc.).

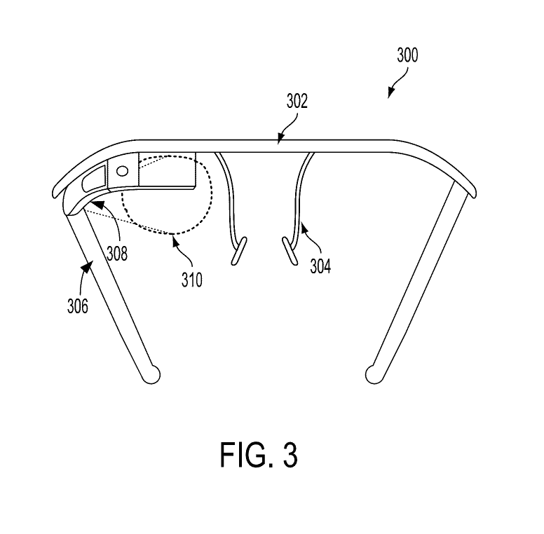

FIG. 3 illustrates an example wearable computing device for implementing side-mounted optical sensors. Within the illustration, the example wearable computing device exists as an HMD 300 that includes a front portion 302, a nose piece 304, multiple side arms, such as side arm 306, sensors 308 configured to capture sensor data corresponding to body elements (e.g., eye region) of a user, and an example area outline 310 that represents a possible area that the sensors 308 of the HMD 300 may be configured to focus upon. Although the example wearable computing device is shown as an HMD 300 in FIG. 3, other wearable computing devices may exist in other structures or formats within other implementations.

Referring to the example HMD shown in FIG. 3, the HMD 300 exists as a wearable glasses frame structure that includes a front portion 302 connecting elements of the HMD 300. The front portion 302 may be configured in other structures and may be composed of various materials, such as plastics or metals, for example. Furthermore, in some instances, the front portion 302 may be configured to provide support or attach to optical elements, such as glasses, prescription lens, sunglasses, etc. (as illustrated in the configuration shown in FIGS. 1A-1C). The optical elements may connect to the front portion 302 outside of the display of the HMD 300 or may connect to the front portion 302 in front of the user's eyes and in front of the HMD's display. The optical elements may attach to the HMD 300 in other portions or sections as well.

Furthermore, the HMD 300 includes a nose piece 304 connected to the front 302. The noise piece 304 may assist in securing the HMD 300 to a user, which may include aligning the display with a user's angle of view. In other examples, an HMD may include other kinds of noise pieces of other structures, or may not include a nose piece at all, for example.

Additionally, the HMD 300 shown in FIG. 3 is configure with multiple side arms, such as side arm 306, which extend away from a connection with the front portion 302 of the wearable frame structure. The side arms, such as side arm 306, may be used to secure the HMD 400 to the face or another body part of a user. In some instances, an HMD may include additional side arms, which may secure the HMD to a user during use. The side arms may extend away from a coupling point with the front portion 302.

Furthermore, the example HMD 300 includes multiple sensors (e.g., sensor 308), which are shown as positioned on the inner side of the side arm 306 proximal to the coupling point between the side arm 306 and the front section 302. For example, the multiple sensors such as sensor 308 may be positioned within a few centimeters (e.g., 0.5-2 cm) proximal to the coupling point. Other distances, such as less than 0.5 cm or greater than 2 cm may exist as proximal within other implementations. In some instances, the HMD 300 may include a single sensor or multiple sensors, such as sensors 308, which may be arranged at different points on the inner surface of the side arm 306 of the HMD 300. The different positions of the sensor 308 on the side arm 306 or aligned on the side with the side arm 306 within different implementations may enable the sensors 306 to receive sensor data at a wide field of view, which may assist the sensors in functioning properly for multiple users. In particular, the positioning of the sensors 308 may enable capturing sensor data for a range of different users, whom may all have different facial structures and other body differences (e.g., location of eyes). The sensors 308 may operate at a wide field of view to accommodate large ergonomic variations that may exist among different users.

In the example illustration, the HMD 300 may include three sensors arranged on the side of one or multiple side arms configured to capture sensor data corresponding to a user. The sensors may be positioned at different points on the inner side of the side arm 306 to enable the sensors to capture sensor data corresponding to an eye region of a user, for example. The sensors may differ and may capture data corresponding to the same or different regions of a user, for example. The sensors may be positioned at a side of the user's temple on the HMD 300 when the HMD is worn to capture sensor data corresponding to eye regions without interference from optical elements configured on the HMD 300.

In some instances, the sensors 308 or some of the sensors 308 may be located within a package or a similar structure coupled to the inner surface of the side arm 306 of the HMD. The package including the sensors 308 may attach to the HMD 300 in a way that positions the package and/or sensors proximal or within a threshold distance from a user's temple when the HMD 300 is worn. For example, the sensors 308 may be within a couple centimeters (e.g., 1-3 cm) of the user's temple when the HMD is being worn. Other distances may exist as proximal as well. In some instances, the package may include sensors, a display, and/or other electronics of the HMD.

As indicated previously, within example implementations, the HMD 300 may include different types of sensors configured to capture sensor data, which may correspond to a user and may be used to determine possible inputs provided by the user. For example, the HMD 300 may include camera sensors or other image capturing sensors. Likewise, the HMD 300 may include proximity sensors or other types of sensors, for example. The HMD 300 may include different types of sensors within the same implementation. Other example sensors may be used as well.

The sensor data may indicate possible input provided by a user. For example, the HMD 300 may process the sensor data to determine whether the user has provided any specific eye gestures that may be indicative of requests from the user for the HMD 300 to perform specific functions. The HMD 300 may be configured to execute a function in response to detecting a wink eye gesture, for example. At the same time, the HMD 300 may be configured to measure a different gesture, such as a blink eye gesture, without executing a function in response. In other cases, the HMD 300 may ignore some gestures from a user, such as gazes or other actions. Other implementations may involve an HMD executing functions based on other requirements or sensor data received corresponding to a user.

In addition, the illustration of FIG. 3 further shows an area 310 that represents a possible area that the sensors 308 of the HMD 300 may be configured to capture sensor data from. For example, the sensors 308 may be configured to capture sensor data, such as movement data or light data corresponding to different regions of a user's eye, which may include eye lids or other muscles/skin associated with a user's eye. Within other implementations, the example area 310 may be larger or smaller depending on one or more parameters of sensors 308 used by the HMD 300 or based on the lighting sources or number of sensors utilized by the HMD 300. Other variables may affect the focus of the sensors as well within other implementations.

Likewise, the sensors 308 may focus upon an outer corner of the user's eye or another position, which may be within the example area 310. The positioning of the sensors on the HMD may capture sensor data from a side angle, which may involve the sensors capturing light data corresponding to a corner of an eye of the user.

In some implementations, the HMD 300 may include one or multiple light sources configured to transmit light upon body elements of a user, such as the user's eye. The addition of transmitted light may enable the sensors of the HMD to capture light data corresponding to an eye of the user. For example, the extra light may enable the sensors to capture sensor data that allows the HMD to determine whether a user is executing a specific eye gesture, such as a wink or blink. The HMD 300 may include one or multiple light sources that may be configured to be adjustable. For example, the user or the HMD 300 may be configured to adjust the position or other parameters associated with the light sources. Likewise, the HMD 300 or user may also be capable of adjusting parameters, such as positioning or focus of the one or more sensors in some implementations as well.

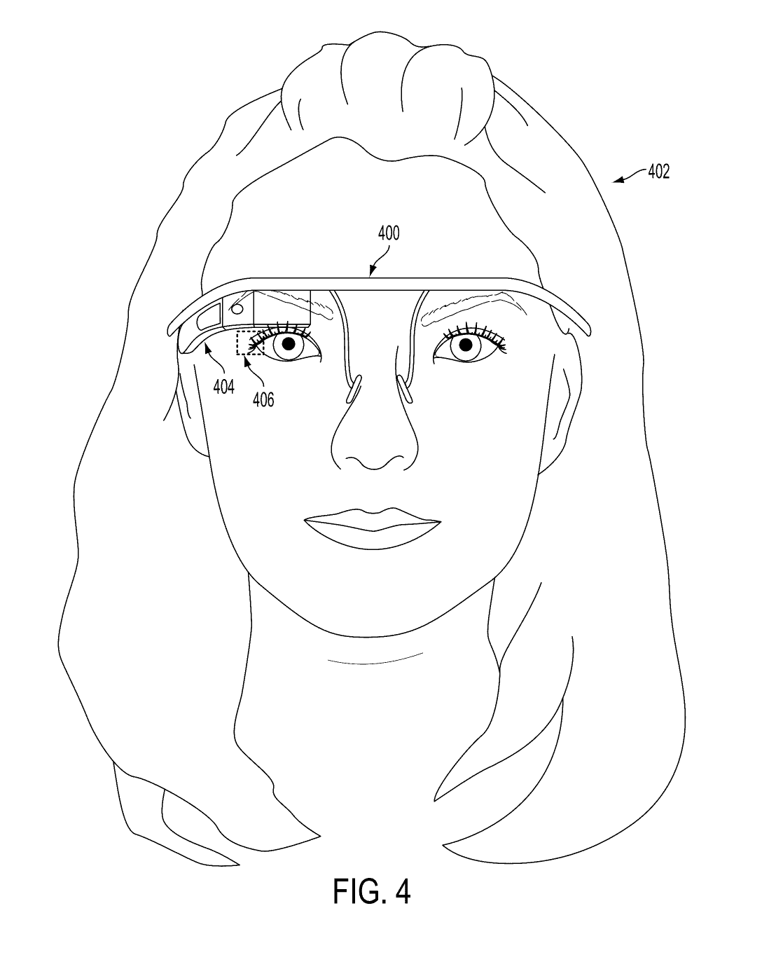

FIG. 4 illustrates another example wearable computing device for implementing side-mounted optical sensors for detecting eye gestures from an example user. Within the example illustration, an example HMD 400 is positioned and secured via structured means on the face of a user 402. In particular, the HMD 400 is secured on the user 402 by its side arms and a nose piece. However, within other examples, the HMD 400 may be secured to a user's body or face via other structures, components or similar means. In some instances, the HMD 400 may be configured to execute functions described herein without having contact or being secured in some manner with a user's body 402.

As shown in FIG. 4, similar to the wearable computing devices discussed in FIG. 1-3, the HMD 400 includes one or multiple sensors 404 positioned on the inner portion of one of the HMD's side arms. The sensors 404 may be configured to capture sensor data for an HMD and may be arranged on the HMD 400 in a manner that allows the sensors to capture sensor data at a wide field of view. For example, the sensors 404 may be arranged on the side arm of the HMD 400 to allow the sensors 404 to capture data at an angle that properly works with a wide range of users that may possess different facial structures. Additionally, the sensors 404 may be positioned to capture data from different distances from the face of the user 402.

In addition, the example HMD 400 may include optical elements, such as glass lens, prescription lens, sun glasses, or other optical elements. The front portion or the wearable frame structure may support or attach the optical elements. The HMD 400 may include sensors 404 positioned in a manner that allows the HMD to include sunglass lens or prescription lens, for example. The sensors 404 may be positioned to an inner side arm of the HMD 400 to prevent interference of lens with the sensors 404 capturing sensor data corresponding to a user's eye region (e.g., eye or eye lids). The sensors 404 may be positioned on the side arm in order to prevent blocking the use of lens, for example. Through positioning the sensors 404 to the side of a user's eye on the HMD 400, the sensors 404 may capture data corresponding to an eye region of the user without interference from the different possible lens elements. Other positions of sensors on an HMD may exist as well.

Furthermore, the example illustration of FIG. 4 shows an area that the one or multiple sensors 404 of the HMD 400 may be configured to capture sensor data from. In particular, the area represents an outside corner region 406 of the user's eye. For example, the sensors 404 of the HMD 400 may capture sensor data, such as light data reflecting off the outer corner of the eye 406 of the user 402. In some instances, gather data from the outer corner of the eye may include gathering data based on movement of the upper eye lid, lower eye lid, and/or other portions of the user 402. Further, the sensors 404 may focus upon other elements of a user or may focus upon multiple sections of an eye, for example.

In another example implementation, an example HMD may exist as a wearable frame structure that includes a front portion and one or multiple side arms to secure the HMD to a user. The side arms may attach to a front portion of the wearable frame structure at multiple coupling points, which connect to front portion of the HMD at ends of the side arms. The side arms may extend away from the front portion of the wearable frame structure.

Furthermore, the HMD may include one or multiple sensors arrange on an inner surface of one or multiple side arms proximal to the coupling points previously identified. The sensors may be positioned on the inner surface in a manner that enables eye detection without interference from the optical elements.

The HMD may further include one or multiple light sources configured to transmit light upon specified regions. For example, the HMD may use light sources to transmit light upon regions of the eye, which may include sections of the eye or the surrounding regions outside of the eye (e.g., eye lids). The sensors of the HMD may use light data sensed corresponding to the eye region of the user to determine if the eye may be making particular gestures, such as a wink or blink eye gesture. The light sources may be positioned within an electronic pod arranged on an inner arm of the HMD. The light sources may be configured to illuminate from multiple positions, which may enable the sensors to receive sensor data that enables the HMD to determine if the data corresponds to a wink or blink eye gesture.

In another example implementation, an HMD may include multiple light-emitting diodes (LED) positioned on an inner arm or another place of the HMD. The HMD may further include another LED positioned at the front of the HMD, such as on the front portion, which may be used for blink detection. The various LEDs may be positioned at different angles to provide light allowing sensors to capture sensor data for the HMD to use for determining and identifying eye gestures. For example, the HMD may include a LED positioned perpendicular to a corner of the eye when the HMD is being worn. Likewise, the HMD may also include another LED positioned in manner that aims backwards at some angle (e.g., 50 degrees) towards an eye region of a user when the HMD is being worn.

In an additional example implementation, an HMD may include one or multiple sensors configured within an electronics pod, which may be positioned on the HMD in a manner that the pod may be positioned near the temple of the user when the HMD is worn. Likewise, an HMD may include multiple electronic pods with respective pods corresponding to different eye regions of the user. For example, an HMD configured as a glasses-style structure with two side arms for securing the HMD to a users' face may include an electronic pod or some other material pod including sensors for detecting sensor data corresponding to eye regions of a user on both side arms of the HMD. The positioning of sensors on an HMD may enable the HMD to extract information from an eye region or other portions of the body of a user. This may enable eyewear frame modularity, which may cause the sensors to obtain sensor data that properly allows a computing system of the HMD to distinctly identify blink or wink eye gestures.

In some example implementations, an HMD may be configured with sensors for detecting eye gestures packaged within other main electronics of the HMD. The package may be connected to the HMD in a way that the sensors do not compete with any eyewear that the HMD may include (e.g., sunglasses, prescription glasses) and may also enable the avoidance of any ambient light challenges that may exist when sensors are positioned outside the eyewear. Furthermore, in some examples, the sensors of an HMD may be placed closer to the display.

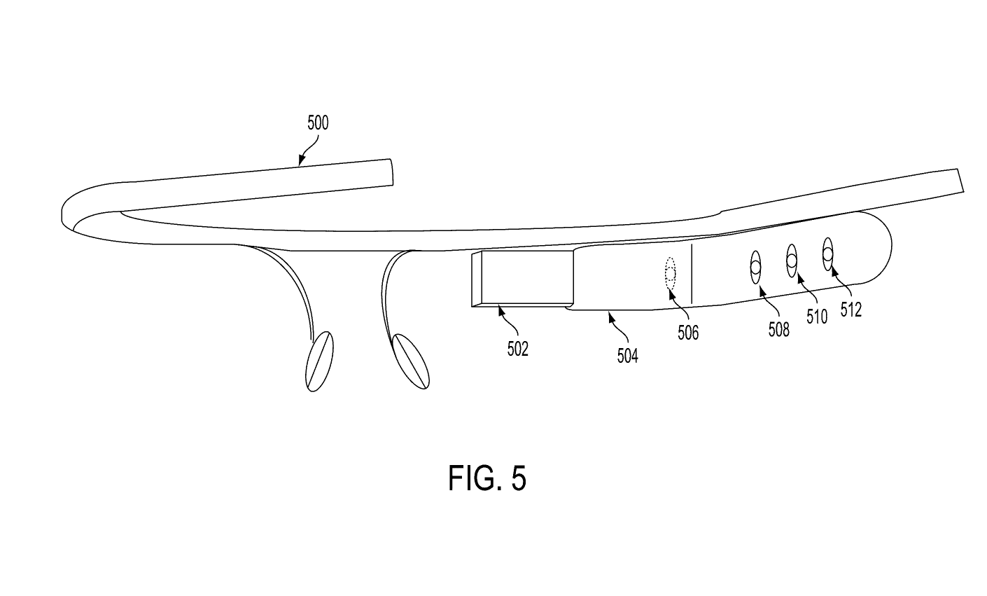

FIG. 5 illustrates another view of an example wearable computing device for implementing side-mounted optical sensors for detecting eye gestures from an example user. Within the illustration of FIG. 5, an example HMD 500 is shown from a view that shows possible placements of sensors on the HMD 500. The example HMD 500 includes a display 502 from an angle that users may view from and further includes an electronics package 504 attached to an arm of the HMD 500. In other examples, the display 502 and the electronics package 504 may vary in size, structure, and placement. For example, the display 502 and electronics package 504 may be connected to the other arm of the HMD 500.

The illustration of the HMD 500 further shows possible placements of sensors on the electronics package 504. In particular, sensor 506 shown in the illustration represents a possible front position of a sensor configured to capture eye data. In this front position, a sensor positioned at sensor 506 may prevent the HMD 500 from allowing a user to use optical lens, such as prescription lens or sunglasses, for example. The sensor may not be able to properly function and gather eye data without distortion with lens in place on the HMD 500 due to the position of the sensor 506. However, the example illustration further shows other possible locations as shown by sensors 508-512 that may enable a sensor to capture eye data properly from a user and also enable the HMD 500 to include optical lens without interfering with the operation of the sensor. The HMD 500 may include one or multiple sensors positioned at any of the sensor locations, including sensors 506-512. In such an example, the HMD 500 may control which sensors may operate. For example, the HMD 500 may utilize one or multiple sensors positioned at sensor 508-512 and not sensor 506 in the case that the HMD 500 has optical elements (e.g., prescription lens) attached to the HMD 500. The sensors 508-512 shown in the illustration may enable the HMD 500 to receive eye sensor data to determine eye gestures without interfering with the vision of the user.

Within other example implementations, the HMD 500 may include sensors positioned on other points of the inner surface of the arm or the electronics package 504 attached to the arm. The sensors 508-512 positioned on the side may capture eye data corresponding to the eye from a specific region, such as the outside corner of the eye, or may receive sensor data from the eye region in general (e.g., eye, eye lids, eye corner). In some instances, the HMD 500 may include a sensor positioned within the display 502 or other positions on the electronics package 504. For example, the sensors may be positioned in a manner that places the sensors closer to the temple of the user when the HMD 500 is being worn. Furthermore, the HMD 500 may also include one or multiple light sources arranged near the sensors for providing light on specific regions of a user.

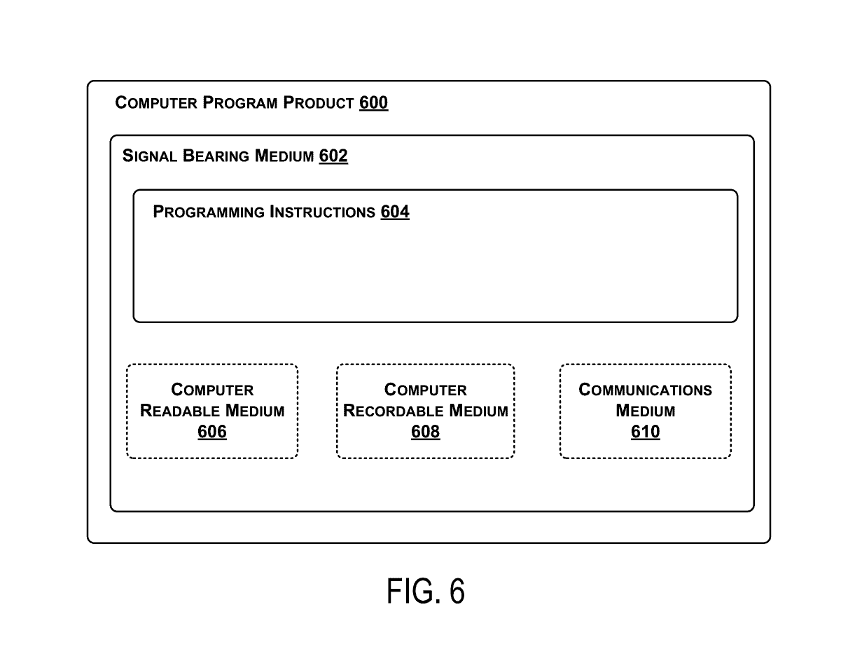

FIG. 6 is a schematic illustrating a conceptual partial view of an example computer program product that includes a computer program for executing a computer process on a computing device, arranged according to at least some embodiments presented herein.

In one embodiment, the example computer program product 600 is provided using a signal bearing medium 602. The signal bearing medium 602 may include one or more programming instructions 604 that, when executed by one or more processors may provide functionality or portions of the functionality described above with respect to FIGS. 1-4. In some examples, the signal bearing medium 602 may encompass a computer-readable medium 606, such as, but not limited to, a hard disk drive, a Compact Disc (CD), a Digital Video Disk (DVD), a digital tape, memory, etc. In some implementations, the signal bearing medium 602 may encompass a computer recordable medium 608, such as, but not limited to, memory, read/write (R/W) CDs, R/W DVDs, etc. In some implementations, the signal bearing medium 602 may encompass a communications medium 610, such as, but not limited to, a digital and/or an analog communication medium (e.g., a fiber optic cable, a waveguide, a wired communications link, a wireless communication link, etc.). Thus, for example, the signal bearing medium 602 may be conveyed by a wireless form of the communications medium 610.

The one or more programming instructions 604 may be, for example, computer executable and/or logic implemented instructions. In some examples, a computing device such as the processor of the previous wearable computing devices may be configured to provide various operations, functions, or actions in response to the programming instructions 604 conveyed to the processor by one or more of the computer readable medium 606, the computer recordable medium 608, and/or the communications medium 610.

The non-transitory computer readable medium could also be distributed among multiple data storage elements, which could be remotely located from each other. The computing device that executes some or all of the stored instructions could be a device, such as the wearable computing device 100 illustrated in FIG. 1. Alternatively, the computing device that executes some or all of the stored instructions could be another computing device, such as a server.

It should be understood that arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims, along with the full scope of equivalents to which such claims are entitled. It is also to be understood that the terminology used herein is for the purpose of describing particular embodiments only, and is not intended to be limiting.

Since many modifications, variations, and changes in detail can be made to the described example, it is intended that all matters in the preceding description and shown in the accompanying figures be interpreted as illustrative and not in a limiting sense.

1. A head-mountable display (HMD) comprising:
a wearable frame structure comprising a front portion and at least one side arm, wherein a given end of the at least one side arm is coupled to the front portion at a coupling point and the at least one side arm extends away from the front portion at the coupling point;
one or more sensors positioned within a package coupled to a surface of the at least one side arm proximal to the coupling point, wherein the one or more sensors are oriented to receive sensor data indicative of movement of an eyelid at an outside corner of at least one eye positioned by the one or more sensors when the head-mountable display is worn;
a first light source positioned within the package coupled to the surface of the at least one side arm proximal to the coupling point, wherein the light source is configured to illuminate the eyelid at the outside corner of the at least one eye positioned by the one or more sensors when the head-mountable display is worn;
a second light source coupled on an inner surface of the front portion of the wearable frame structure, wherein the second light source is configured to illuminate a portion of the at least one eye positioned by the one or more sensors when the head-mountable display is worn; and
a processor configured to perform one or more functions based on sensor data indicative of movement of the eyelid at the outside corner of the at least one eye provided by the one or more sensors, wherein the processor is configured to use illumination from the first light source and sensor data indicative of movement of the eyelid at the outside corner of the at least one eye to detect a winking eye gesture by the at least one eye, and wherein the processor is configured to use illumination from the second light source and sensor data indicative of movement of the eyelid at the outside corner of the at least one eye to detect a blinking eye gesture by the at least one eye.

2. (canceled)

3. The HMD of claim 1, wherein the sensor data is indicative of one or more of light data or movement data corresponding to the at least one eye region.

4. (canceled)

5. (canceled)

6. The HMD of claim 1, wherein the package coupled to the inner surface of the at least one side arm also comprises a plurality of electronics of the HMD.

7. The HMD of claim 1, wherein the package coupled to the at least one side arm is further positioned proximal to a temple of a user when the HMD is worn.

8. (canceled)

9. The HMD of claim 1, wherein the one or more sensors include at least one proximity sensor.

10. The HMD of claim 1, wherein the one or more sensors include one or more of a camera, a sensor array, image sensor, light sensor, and infrared sensor.

11. A head-mountable display (HMD) comprising:
a wearable frame structure comprising a front portion and at least one side arm, wherein the front portion is configured to hold one or more optical elements in front of at least one eye region when the head-mountable display is worn, and wherein a given end of the at least one side arm is coupled to the front portion at a coupling point and the at least one side arm extends away from the front portion at the coupling point;
one or more optical elements coupled to the front portion;
one or more sensors positioned within a package coupled to a surface of the at least one side arm proximal to the coupling point, wherein the one or more sensors are oriented to receive sensor data indicative of movement of an eyelid at an outside corner of at least one eye positioned by the one or more sensors when the head-mountable display is worn;
a first light source positioned within the package coupled to the surface of the at least one side arm proximal to the coupling point, wherein the light source is configured to illuminate the eyelid at the outside corner of the at least one eye positioned by the one or more sensors when the head-mountable display is worn;
a second light source coupled on an inner surface of the front portion of the wearable frame structure, wherein the second light source is configured to illuminate a portion of the at least one eye positioned by the one or more sensors when the head-mountable display is worn; and
a processor configured to perform one or more functions based on sensor data indicative of movement of the eyelid at the outside corner of the at least one eye provided by the one or more sensors, wherein the processor is configured to use illumination from the first light source and sensor data indicative of movement of the eyelid at the outside corner of the at least one eye to detect a winking eye gesture by the at least one eye, and wherein the processor is configured to use illumination from the second light source and sensor data indicative of movement of the eyelid at the outside corner of the at least one eye to detect a blinking eye gesture by the at least one eye.

12. The HMD of claim 11, wherein the one or more optical elements coupled to the front portion include one or more of protective lens and prescription lens.

13. The HMD of claim 11, further comprising one or more adjustable light sources configured to transmit light on one or more regions of the at least one eye region when the head-mountable display is worn.

14. The HMD of claim 11, further comprising:
at least one processor configured to determine, based on the sensor data, whether the sensor data corresponds to a wink eye gesture, wherein the at least one processer is further configured to provide instructions to one or more components of the HIVID in response to determining that the sensor data corresponds to the wink eye gesture.

15. The HMD of claim 11, further comprising:
at least one processor configured to determine, based on the sensor data, whether the sensor data corresponds to blink eye gesture, wherein the at least one processor is further configured to provide instructions to one or more components of the HMD in response to determining that the sensor data corresponds to the blink eye gesture.

16. A wearable computing system comprising:
a wearable frame structure comprising a front portion and at least one side arm, wherein a given end of the at least one side arm is coupled to the front portion at a coupling point and the at least one side arm extends away from the front portion at the coupling point;
a display coupled to the wearable frame structure, wherein the display is configured to display information;
one or more sensors positioned within a package coupled to a surface of the at least one side arm proximal to the coupling point, wherein the one or more sensors are oriented to receive sensor data indicative of movement of an eyelid at an outside corner of at least one eye positioned by the one or more sensors when the head-mountable display is worn;
a first light source positioned within the package coupled to the surface of the at least one side arm proximal to the coupling point, wherein the light source is configured to illuminate the eyelid at the outside corner of the at least one eye positioned by the one or more sensors when the head-mountable display is worn;
a second light source coupled on an inner surface of the front portion of the wearable frame structure, wherein the second light source is configured to illuminate a portion of the at least one eye positioned by the one or more sensors when the head-mountable display is worn; and
a processor configured to perform one or more functions based on sensor data indicative of movement of the eyelid at the outside corner of the at least one eye provided by the one or more sensors, wherein the processor is configured to use illumination from the first light source and sensor data indicative of movement of the eyelid at the outside corner of the at least one eye to detect a winking eye gesture by the at least one eye, and wherein the processor is configured to use illumination from the second light source and sensor data indicative of movement of the eyelid at the outside corner of the at least one eye to detect a blinking eye gesture by the at least one eye.

17. (canceled)

18. (canceled)

19. The wearable computing system of claim 16, further comprising:
one or more optical elements, wherein the wearable frame structure is configured to support the one or more optical elements.

20. (canceled)
